(19) United States
(12) Patent Application Publication
(10) Pub. No.: US 2012/0271652 A1
(43) Pub. Date: Oct. 25, 2012

(54) GRAPHICAL ON-SCREEN BED BOARD WITH PORTABLE PATIENT CARD

(75) Inventors: Linda Shipman Ellis, Matthews, NC (US); David Paul Carlson, Shoreview, MN (US); Sherry Dean, Alpharetta, GA (US)

(73) Assignee: MCKESSON TECHNOLOGIES INC., Alpharetta, GA (US)

(21) Appl. No.: 13/462,380

(22) Filed: May 2, 2012

Related U.S. Application Data
(63) Continuation of application No. 11/119,462, filed on Apr. 29, 2005, now abandoned.

(51) Int. Cl. G06Q 50/22

(52) U.S. Cl. 705/2

(57) ABSTRACT

An electronically generated bed board is primarily comprised of a plurality of graphical representations of bed cells each having associated therewith a set of bed attributes and a plurality of graphical representations of patient cards each having associated therewith a set of patient attributes. Each patient card may be displayed as either assigned to a bed cell or unassigned. A graphical representation for grouping beds that are in the same room may also be provided. A holding area may be provided in which unassigned patient cards can be displayed. A reservation card capable of being assigned to a bed cell may also be provided. The present disclosure is also directed to methods of using the bed board to model (try) different patient configurations by dragging and dropping patient cards and reservation cards among bed cells and the holding area.

This application is a continuation of U.S. application Ser. No. 11/119,462, filed Apr. 29, 2005, the contents of which is incorporated herein by reference.

### BACKGROUND

The present disclosure is related generally to the field of resource management and, more particularly, to the management of beds and other resources in a health care facility.

The assignment of beds in hospitals and other health care facilities is a complicated matter. Patients may have special needs which require placement in rooms having the proper equipment for such needs. Patients may have diseases which require quarantine, or may require a private (one bed) room for other reasons. Bed assignments need to be correlated with other systems to insure that medications for all patients in, for example, a nursing wing, are delivered to that wing. The proper location of patients is needed for other reasons. For example, a physical therapist needs to know the proper location of all patients which are to receive therapy on his or her current rounds to enable such therapy to be delivered in a timely manner. They need to know the proper location of patients that need to be transported for tests such as x-ray, CAT scan, among others, is obvious.

Current solutions to assignment of beds and other resources include a physical “bed board” in, for example, a nursing wing. The bed board is a physical representation of the beds in that wing, and has slots for patient identification cards. While such a system may provide some localized information, and may provide for the display of a large amount of information, it provides no interface to other hospital resources. For example, such a physical bed board is of no help to a centrally located pharmacy having automation equipment for filing prescriptions for the nursing wing, is of no help to a physical therapist trying to schedule his rounds for the day, and is of no help to an x-ray technician trying to locate a patient that is scheduled for x-rays, among others.

Another solution is found in US 2003/0074222 A1 published Apr. 17, 2003 and entitled System and Method for Managing Patient Bed Assignments and Bed Occupancy in a Health Care Facility. That publication discloses an integrated health care delivery network with enabling software and network technology to maximize bed resources, manage varying census levels, and avoid patient diversions through real-time monitoring, automation and communication. Preferably, the invention is embodied in a bed management system that interfaces with and complements existing Admission/Discharge/Transfer (ADT) systems. The bed management system is a business intelligence application that is designed to allow administrators, clinicians and managers to access, analyze and display real-time patient and bed availability information from ancillary information systems, databases and spreadsheets. It enables users to see trends and relationships in hospital (bed) management data directly from their desktop personal computers.

The prior art fails to provide an easy to use device, that displays all the necessary information in a dense yet easy to understand format, that easily interfaces with other healthcare systems such as pharmacy, billing and ADT systems, among others.

### BRIEF SUMMARY

The present disclosure is directed to an electronically generated bed board comprising a plurality of graphical representations of bed cells each having associated therewith a set of bed attributes and a plurality of graphical representations of patient cards each having associated therewith a set of patient attributes. Each patient card may be displayed as either assigned to a bed cell or unassigned. The set of bed attributes may be comprised of at least one of ready, hold, out of service, exceed Expected Length of Stay (ELOS), patient has alerts, ready with reservation, intent to discharge, intent to transfer, or out of service, among others. The set of patient attributes is comprised of at least one of gender, patient type, age, has alert, currently selected, enabled for use inside a room cell, or enabled for use inside a holding area, among others. A graphical representation for grouping beds that are in the same room may also be provided. A holding area may be provided in which unassigned patient cards can be displayed. A reservation card capable of being assigned to a bed cell may also be provided.

The present disclosure is also directed to methods of using the bed board to model (try) different patient configurations by dragging and dropping patient cards and reservation cards among bed cells and the holding area. When a final configuration is obtained, that configuration may be saved. Hardware in the form of a computer and a computer system in combination with computer readable media capable of generating and manipulating the electronically generated bed board are also disclosed.

### BRIEF DESCRIPTION OF THE DRAWINGS

For the present disclosure to be easily understood and readily practiced, the present invention will now be described, for purposes of illustration and not limitation, in conjunction with the following figures, wherein:

FIG. 1 illustrates an electronically generated, graphical representation of a bed board;

FIGS. 2A-2D illustrate examples of patent cards;

FIGS. 3A-3J illustrate examples of bed cells;

FIG. 4 illustrates how beds in the same room may be graphically grouped;

FIG. 5 illustrates how additional information may be displayed;

FIGS. 6A and 6B illustrate the use of a reservation card;

FIG. 7 illustrates a bed board with a holding/transfer area;

FIG. 8 illustrates a bed board organized according to nursing stations;

FIG. 9 illustrates a bed board operating in a split screen mode;

FIG. 10 illustrates filters for customizing the bed board;

FIG. 11 illustrates a processing system on which the electronic bed board 10 may be generated and displayed; and

FIG. 12 illustrates a simplified diagram of a computing system incorporating the processing system of FIG. 11 according to one embodiment.

### DETAILED DESCRIPTION OF THE INVENTION

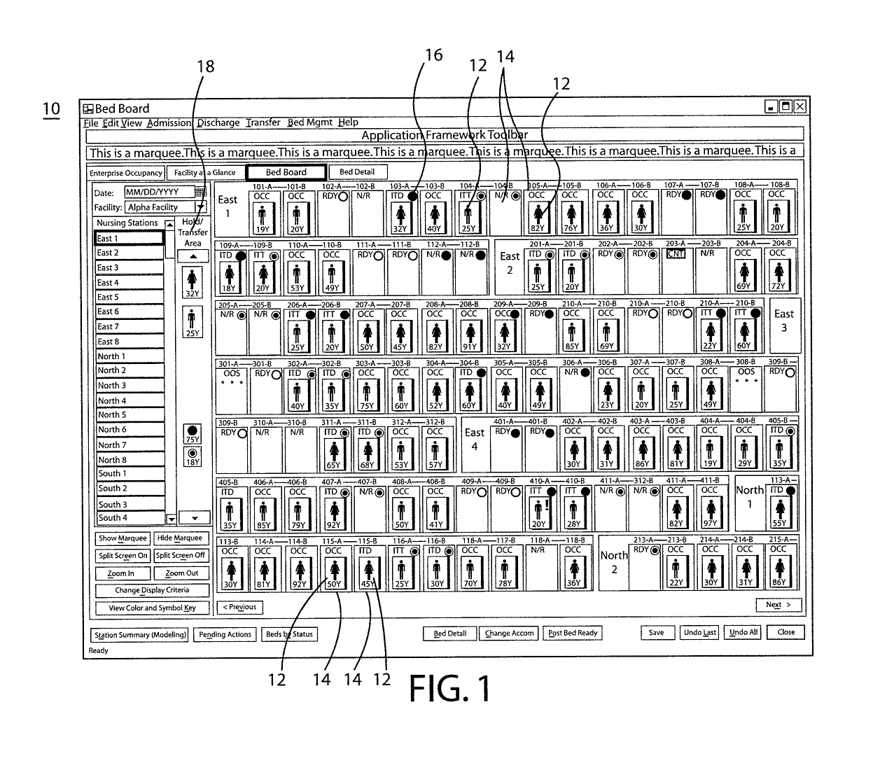

FIG. 1 illustrates an electronically generated, graphical representation of a bed board 10. The on-screen bed board 10 is a high density, graphical representation of bed location, status, and bed activity as well as a patient's primary location, a patient's information set, and bed reservation information. The electronically generated bed board 10 is comprised primarily of a plurality of graphical representations of patient cards 12 and graphical representations of bed cells 14.

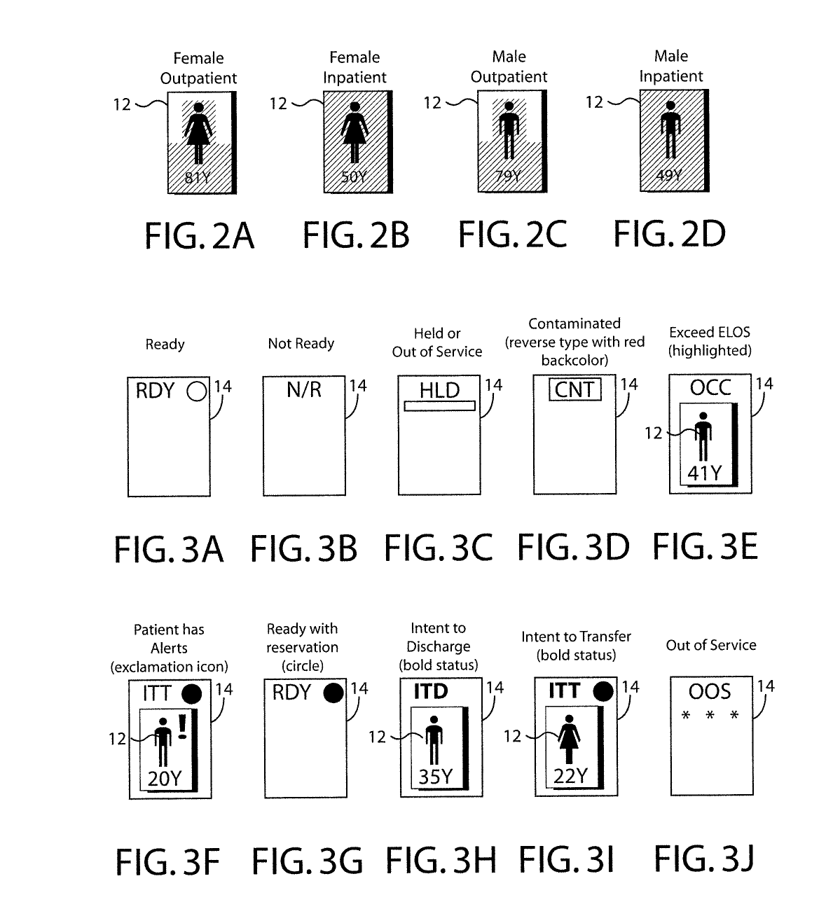

FIGS. 2A-2D illustrate examples of patient cards 12. Each patient card 12 is a compact graphical representation which has associated therewith a set of patient attributes. The set of patient attributes can vary depending upon the needs and wishes of the user but may include, for example, gender, patient type, age, has alert, currently selected, enabled for use inside a room cell/enabled for use inside a holding area, among others. Cards for male (FIG. 2C, 2D) and female (FIG. 2A, 2B) patients are visually different, e.g. different symbols, blue icon for male, pink icon for female, etc.). Cards may also display physical differences, for example, for inpatients versus outpatients, adults vs. children, etc.

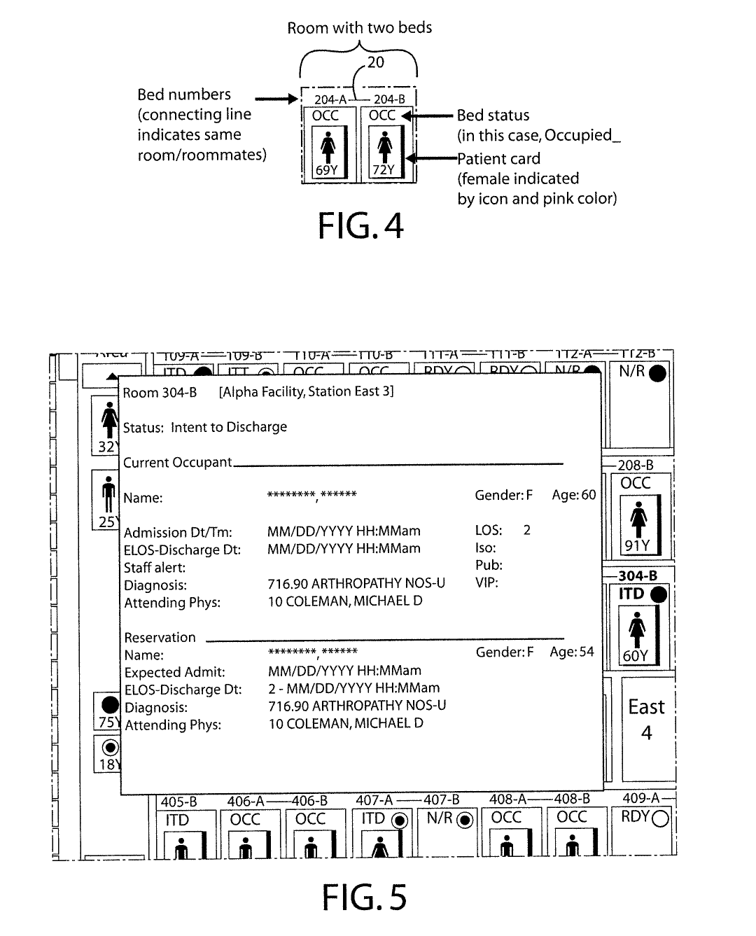

FIGS. 3A-3J illustrate examples of bed cells 14. Each bed cell 14 is a compact graphical representation having associated therewith a set of bed attributes. The bed attributes can be selected according to the needs and wishes of the user. The bed attributes may include, for example, ready, hold, out of service, exceed ELOS, patient has alerts, ready with reservation, intent to discharge, intent to transfer, or out of service, among others. FIGS. 3E, 3F, 3H and 3I illustrate bed cells 14 having patient cards 12 assigned thereto. As seen from FIGS. 3A-3J, both the patient cards 12 and bed cells 14 display a substantial amount of information in a dense but intuitive, easy to understand manner. The appearance of a bed cell 14 differs depending on the condition/status of the bed. For example, the bed cell 14 of FIG. 4A has a status of ready (RDY), the bed cell 14 of FIG. 4B has a status of not ready (N/R), the bed cell 14 of FIG. 4C has a status of held or out of service (HLD with bar), etc. Clicking on a bed cell 14 selects that bed cell. The bed cell may be highlighted, indicating its “selected” state. Through drag and drop (mouse, touch, or other interface), or keyboard selections, the user can move a patient card from one bed cell 14 to another. The bed cells 14 may be thought of as “bed slots” when thinking of the electronic bed board 10 as a physical “on the wall” bed board which would typically have slots for inserting patient cards.

The electronic bed board 10 also includes a graphical representation 20, see FIG. 4, which illustrates the grouping of beds that are in the same room. More specifically, bed numbers interconnected by line 20 indicates the beds are in the same

More detailed information about a bed, its current occupancy, or existing reservations may be displayed in an overlay as shown in FIG. 5 that is visible when the mouse cursor is paused over any of the patient cards 12 or bed cells 14.

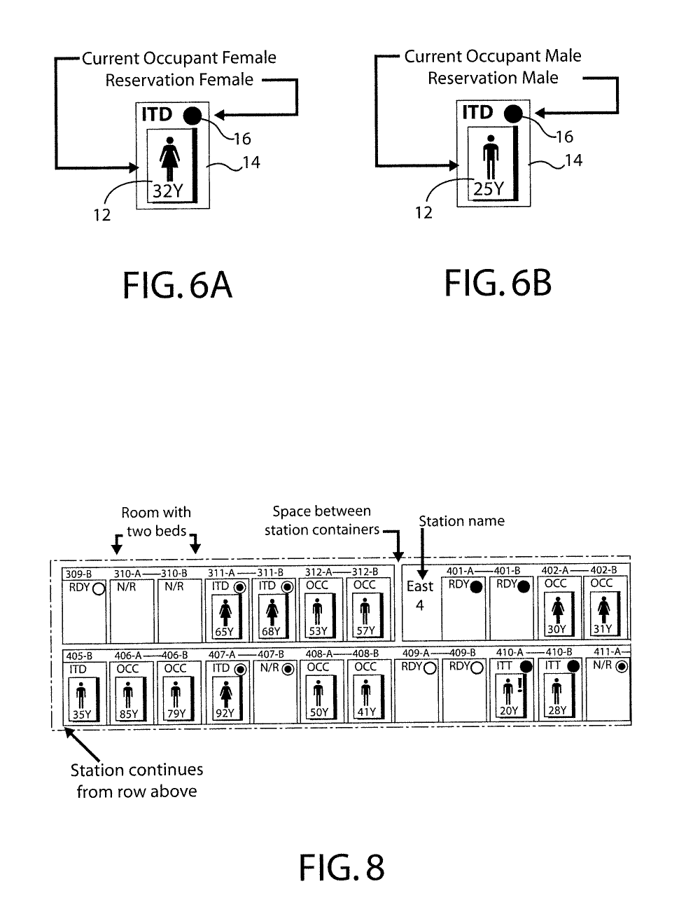

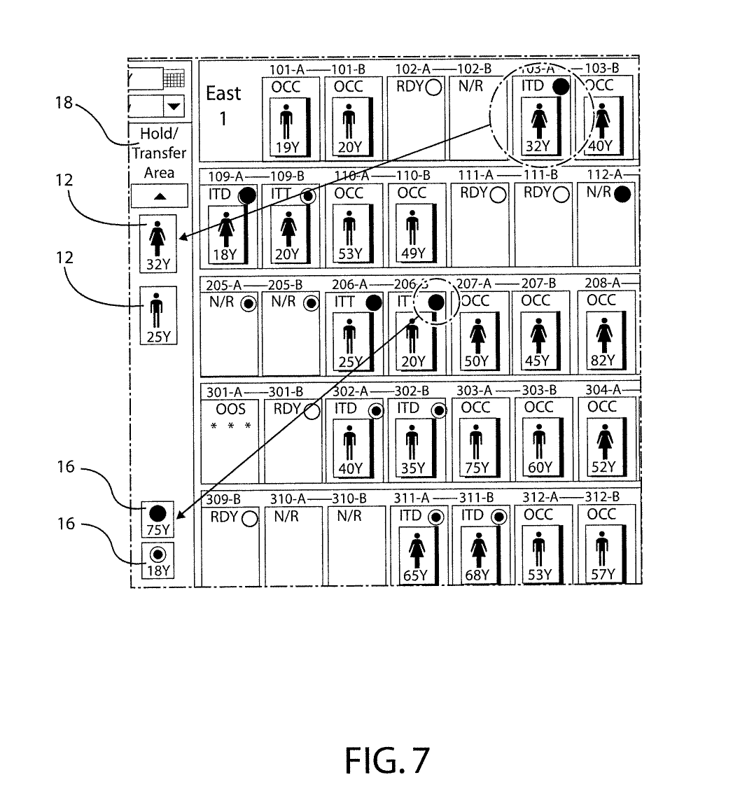

A reservation card 16 is shown in FIGS. 6A and 6B in association with patient cards 12 assigned to bed cells 14. In FIG. 6A the bed cell 14 has a status of intent to discharge the current female occupant and, at the same time, has a reservation for a new female patient. In FIG. 6B, the bed cell 14 indicates that the current male occupant is intended to be discharged, and that bed is currently reserved for a different male patient. When the reservation card 16 is not assigned to a specific bed, the reservation card 16 may be held in a holding area 18. The holding area 18 is best seen in FIG. 7. Reservation cards 16 can be moved among bed cells 14 and/or the holding area 18. A reservation card 16 may be likened to a small, or miniature version of a patient card. It behaves like a patient card in most ways including showing an information overlay when the focus hovers over it. However, there are differences. (1) When dropped on a bed cell, the reservation card does not occupy the center portion as does the patient card. (2) In the current drawing, when dropped on a bed cell, the enclosing borders (the outline of the “card”) are not visible. It is shown in that manner to avoid visual clutter. (3) When the reservation card is dropped in the holding area, more information is visible. For example, if known, the patient's age is shown and the borders of the card are visible. (4) The icon (a circle is shown in these drawings) on the reservation card is more general/abstract than the icon representation on the patient card to avoid visual clutter and to distinguish it as different from the patient card.

Normal bed management business rules may apply to moving the reservation card 16. Information about the other occupant of a room, in those rooms which have multiple beds, is also considered when making a reservation or placing a patient in a bed. The electronic bed board 10, as previously mentioned, graphically associates beds that are in the same room. Adjustable display criteria settings determine whether both (or all) beds in a room are displayed even if the roommate bed does not match the overall display criteria (filter) choices.

As may be appreciated by those of ordinary skill in the art, the electronically generated bed board 10 may be used in a manner similar to a “on the wall” bed board having bed slots and patient cards. The holding area 18 may be a temporary “parking” area for patient cards 12. A patient card 12 can be dragged from a bed cell 14 and dropped into the holding area 18, or vice versa. Note that the cards 12 in the holding area 18 represent patients, and not beds. Beds are not moved into the holding area 18, only patient cards 12 and reservation card 16 are moved into the holding area 18. After a patient card 12 is removed from a bed cell 14, the bed status (and the appearance of bed cell) temporarily changes to reflect that there is no longer a patient in the bed. When a patient card 12 is dragged from the holding area 18 and dropped into a bed cell 14, that action temporarily associates that patient with that bed. In this manner, the user may try a variety of different patient/room assignments until some optimized or otherwise desirable configuration is achieved. During this “modeling” stage, the various associations are temporarily saved. The assignment becomes final when the user clicks on a save button, or takes other appropriate actions to indicate that the current configuration of the bed board 10 is the configuration to be saved. That allows the user to model (try) different assignment scenarios before saving a final one.

It is anticipated that the patient card 12 may be used in other application programs, or may be used as a container for passing patient attributes between applications. Thus, the patient card may be thought of as a portable representation of the patient and the associated set of patient information or patient attributes. For example, in settings where the visual identification of an individual is important, the person icon on the patient card could be replaced by a thumbnail photo of the person. This could assist with locating a person, or in the case of a kiosk display, help a person find his/her own card on a display. (This usage would be practical in settings where privacy concerns are not foremost.) As another example, a row of patient cards may be accumulated in a patient banner to facilitate working with a set of patients and switching context amongst those patients. A patient card might be used anywhere a compact graphical representation of the patient and his/her associated attributes, medical information set, etc. is needed. After room assignments are made, the information can be passed along to other hospital systems such as pharmacy, billing, ADT, among others.

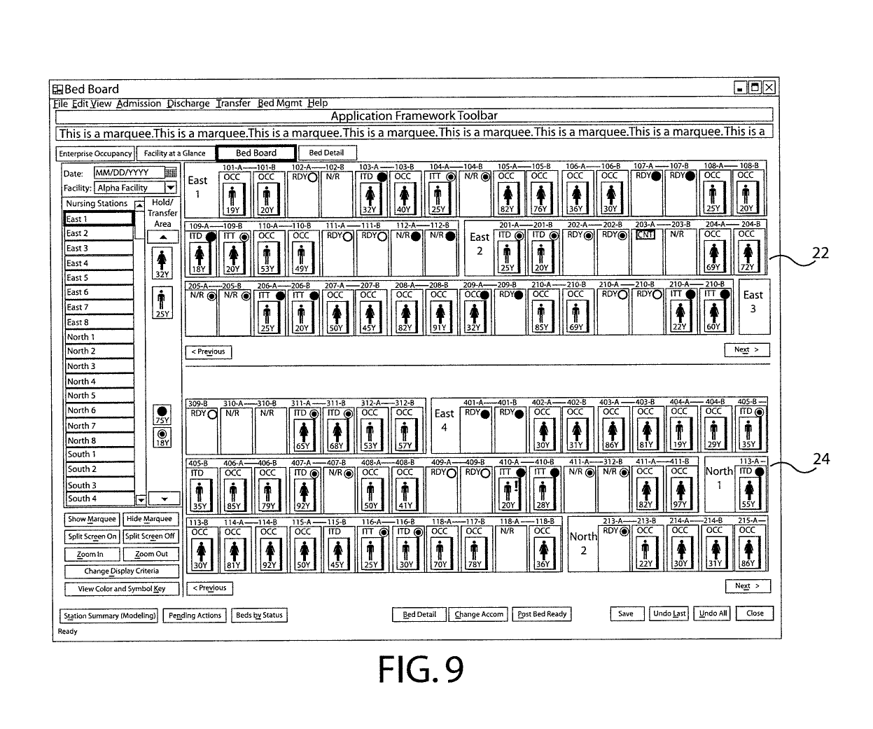

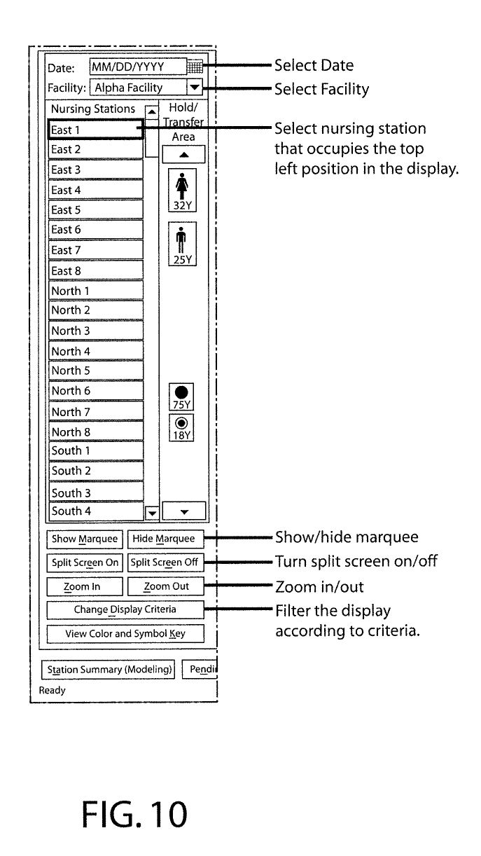

The electronic bed board 10 of the present invention is very flexible in terms of the manner in which the information may be displayed. For example, in FIG. 8, the bed board 10 is organized according to nursing stations. In this mode, the nursing station may be thought of as a container for rooms, with the rooms assigned to that nursing station flowing from one row to the next. FIG. 9 illustrates a split screen mode which provides two bed display panes 22 and 24. Each pane can be filtered and customized individually as discussed below in conjunction with FIG. 10. Patient cards can be dragged/dropped between the panes 22, 24. For example, the top pane 22 might display beds for facility one while the bottom pane 24 displays beds for facility two. This enables a user with the appropriate privileges to move a patient bed assignment, or reservation, from one facility to another. For the bed board and other location-related functions, adding a floor plan view/mode would enable drag/dropping a patient card over a more realistic background. This would be practical in settings where the display does not need to be as dense, i.e. does not need to display so many beds at once.

FIG. 10 illustrates a screen shot of a tool that enables a user to change the characteristics of the electronic bed board 10. As seen from FIG. 10, after selecting the desired nursing station, various options appearing at the bottom of the screen shot in FIG. 10 may be made available to the user to customize or filter the appearance of the bed board 10. Those familiar with computer programming will recognize that as much or as little customization can be made available to the user as desired. Additionally, the ability to customize or filter the appearance of the bed board 10 will most likely be linked to a user's clearance level, with those individuals having a higher clearance level being provided with more options.

FIG. 11 is a simplified diagram of a processing system 100 on which code for generating and manipulating the electronic bed board 10 may reside according to the current embodiment. The processing system 100 may include a central processing unit (CPU) 105 in communication with a data storage device 101, a video driver 106, a communications port 107, a memory device 108, and an input/output driver 109, among others. The CPU 105 may be a microprocessor, micro-controller, and ASIC, among others. The CPU 105 is capable of performing various computing functions, such as executing software functions to perform specific calculations and/or data processing tasks. In the current embodiment, the CPU 105 is operable to implement the bed board 10 as discussed above.

The data storage device 101 may be a CD-ROM, disk drive, tape drive, ZIP drive, etc. which is operable to store various software and data sets for use by processing system 100. In the current embodiment, the data storage device may be used to store an operating system 102 (e.g., Windows®, etc.) and the instructions/code 103 for the electronic bed board 10, among others. The memory device 108 may be a dynamic random access module (DRAM), flash memory, static memory, read-only memory (ROM) device, etc. that may be used, for example, to temporarily store instructions and data that are frequently accessed by CPU 105. Video driver 106 is operable to drive a monitor (e.g., monitor 120 as illustrated in FIG. 12), communications port 107 provides an interface between the processing system 100 and one or more communication devices (not shown), and I/O driver 109 is an interface between various input devices (e.g., keyboard, mouse, microphone, bar code reader, RFID reader, touch screen, etc.) and output devices (e.g., printers, speakers, etc.).

FIG. 12 is a simplified diagram of a computer system 90 incorporating the processing system 100 of FIG. 11 according to one embodiment. The computing system 90 includes a keyboard 130 and mouse 140 connected to the processing system 100 (e.g., via I/O driver 109) to allow a user to manually input data, instructions, etc., to operate the processing system 100. The computing system also includes a monitor 120 and printer 125 connected to the processing system 100 (e.g., via video driver 106 and I/O driver 109, respectively) to display or otherwise output data generated by the processing system 100. Computing system 90 may also include mixed input/output devices (not shown) such as modems, network interface cards, and touch screens (among others) which may be connected of the processing system 100 (e.g., via communication port 107).

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. An apparatus comprising a processor configured to cause the apparatus to generate a bed board, the bed board comprising:
a plurality of graphical representations of bed cells, each graphical representation of a bed cell having associated therewith a bed and a set of bed attributes;
a plurality of graphical representations of patient cards, each patient card having associated therewith a set of patient attributes, wherein each patient card is displayed as either assigned to a bed cell or unassigned, wherein each patient card assigned to a bed cell is displayed within a respective assigned bed cell, and wherein each patient card is assignable to a bed cell by dragging and dropping the patient card onto a bed cell; and
a graphical representation of a reservation card having associated therewith a set of patient attributes, wherein the reservation card is displayed as assigned to a bed cell to which a patient card is also assigned, wherein the patient card assigned to the bed cell to which the reservation card is assigned is associated with a patient to be discharged.

2. The apparatus of claim 1, wherein said set of bed attributes is comprised of one or more of ready, hold, exceed ELOS, patient has alerts, ready with reservation, intent to discharge, intent to transfer, or out of service.

3. The apparatus of claim 1, wherein said set of patient attributes is comprised of one or more of gender, patient type, age, has alert, currently selected, enabled for use inside a room cell, or enabled for use inside a holding area.

4. The apparatus of claim 1, wherein the bed board additionally comprises a graphical representation for grouping graphical representations of bed cells associated with beds that are in the same room.

5. The apparatus of claim 1, wherein the bed board additionally comprises a holding area in which one or more unassigned patient cards are displayed.

6. The apparatus of claim 1, wherein said bed cells are organized by nursing station.

7. The apparatus of claim 1, wherein each patient card comprises a container for the set of patient attributes associated therewith that is configured for passing the set of patient attributes associated therewith to another application.

8. The apparatus of claim 1, wherein the bed cell to which the reservation card is assigned has a status of intent to discharge.

9. A computer program product comprising at least one non-transitory computer readable medium, the at least one non-transitory computer readable medium storing a set of instructions which, when executed, generates a display of a bed board comprising:
a plurality of graphical representations of bed cells, each graphical representation of a bed cell having associated therewith a bed and a set of bed attributes;
a plurality of graphical representations of patient cards, each patient card having associated therewith a set of patient attributes, wherein each patient card is displayed as either assigned to a bed cell or unassigned, wherein each patient card assigned to a bed cell is displayed within a respective assigned bed cell, and wherein each patient card is assignable to a bed cell by dragging and dropping the patient card onto a bed cell; and
a graphical representation of a reservation card having associated therewith a set of patient attributes, wherein the reservation card is displayed as assigned to a bed cell to which a patient card is also assigned, wherein the patient card assigned to the bed cell to which the reservation card is assigned is associated with a patient to be discharged.

10. The computer program product of claim 9, wherein said set of bed attributes is comprised of one or more of ready, hold, exceed ELOS, patient has alerts, ready with reservation, intent to discharge, intent to transfer, or out of service.

11. The computer program product of claim 9, wherein said set of patient attributes is comprised of one or more of gender, patient type, age, has alert, currently selected, enabled for use inside a room cell, or enabled for use inside a holding area.

12. The computer program product of claim 9, wherein the bed board additionally comprises a graphical representation for grouping graphical representations of bed cells associated with beds that are in the same room.

13. The computer program product of claim 9, wherein the bed board additionally comprises a holding area in which one or more unassigned patient cards are displayed.

14. The computer program product of claim 9, wherein said bed cells are organized by nursing station.

15. The computer program product of claim 9, wherein each patient card comprises a container for the set of patient attributes associated therewith that is configured for passing the set of patient attributes associated therewith to another application.

16. The computer program product of claim 9, wherein the bed cell to which the reservation card is assigned has a status of intent to discharge.

17. A method of electronically generating a representation of a bed board, comprising:
generating, by a processor, a plurality of graphical representations of bed cells, each graphical representation of a bed cell having associated therewith a bed and a set of bed attributes;
generating, by the processor, a plurality of graphical representations of patient cards, each patient card having associated therewith a set of patient attributes, wherein each patient card is displayed as either assigned to a bed cell or unassigned, wherein each patient card assigned to a bed cell is displayed within a respective assigned bed cell, and wherein each patient card is assignable to a bed cell by dragging and dropping the patient card onto a bed cell; and
generating, by the processor a graphical representation of a reservation card having associated therewith a set of patient attributes, wherein the reservation card is displayed as assigned to a bed cell to which a patient card is also assigned, wherein the patient card assigned to the bed cell to which the reservation card is assigned is associated with a patient to be discharged.

18. The method of claim 17, wherein said set of bed attributes is comprised of one or more of ready, hold, exceed ELOS, patient has alerts, ready with reservation, intent to discharge, intent to transfer, or out of service.

19. The method of claim 17, wherein said set of patient attributes is comprised of one or more of gender, patient type, age, has alert, currently selected, enabled for use inside a room cell, or enabled for use inside a holding area.

20. The method of claim 17, additionally comprising generating a graphical representation for grouping graphical representations of bed cells associated with beds that are in the same room.

21. The method of claim 17, additionally comprising generating a holding area in which one or more unassigned patient cards are displayed.

22. The method of claim 17, additionally comprising organizing said bed cells by nursing station.

23. The method of claim 17, wherein each patient card comprises a container for the set of patient attributes associated therewith that is configured for passing the set of patient attributes associated therewith to another application.

24. The method of claim 17, wherein the bed cell to which the reservation card is assigned has a status of intent to discharge.
